(19) United States
(12) Patent Application Publication
(10) Pub. No.: US 2009/0151212 A1
(43) Pub. Date: Jun. 18, 2009

(54) Aerodynamic Sign Display Device

(76) Inventor: Gonzalo A. CADAVIS, Winnipeg (CA)

Correspondence Address: ADE & COMPANY INC., 2157 Henderson Highway, WINNIPEG, MB, R2G1P9, CA

(21) Appl. No.: 11/958,437

(22) Filed: Dec. 18, 2007

(51) Int. Cl. G09F 7/00

(52) U.S. Cl. 40/611.07

(57) ABSTRACT

An aerodynamic sign displaying device comprises a sleeve member rotatably supported on a post, a mounting frame extend radially outward from the sleeve member, and a panel member on the mounting frame which displays a sign thereon. The panel member is slidably received in the mounting frame along a plane of the panel member for sliding in a radial direction relative to the sleeve member such that the panel member is readily separable from mounting frame.

### FIELD OF THE INVENTION

The present invention relates to an aerodynamic sign display device arranged to support a panel on a post in which the panel displays a sign thereon, for example an advertising sign, and more particularly relates to a display device arranged to support a sign for rotation about the post.

### BACKGROUND

The demand for advertising is well-known and accordingly there is a constant desire for innovative ways to attract attention to advertising.

One example is disclosed in Canadian patent application 2,362,624 belonging to Cadavis in which a sign is supported as a flag type banner which orients itself relative to prevailing winds about a post upon which it is mounted. The particular construction of the sign disclosed is somewhat complex and accordingly changing the sign may require considerable effort on the part of the user.

### SUMMARY OF THE INVENTION

According to one aspect of the invention there is provided an aerodynamic sign displaying device for supporting a sign on a post, the device comprising:

a sleeve member arranged to be supported about the post for rotation relative to the post about a longitudinal axis of the sleeve member;

a mounting frame supported on the sleeve member to extend radially outward from the sleeve member in relation to the longitudinal axis; and

a panel member arranged to display the sign;

the panel member being slidably received in the mounting frame such that the panel member is readily separable from mounting frame.

By providing a frame which slidably mounts a panel member displaying a sign thereon relative to the post upon which it is mounted so as to be readily separable, a simple construction is provided which also permits the sign to be readily changed as desired.

The panel member is preferably slidable relative to the mounting frame along a plane containing the longitudinal axis of the sleeve member in a radial direction extending outwardly from the longitudinal axis of the sleeve member.

The mounting frame may comprise a pair of channels having a generally U-shaped cross section oriented with respective open sides facing one another so as to be arranged for receiving respective top and bottom edges of the panel member slidably therein.

The channels preferably extend radially outward from the longitudinal axis of the sleeve member and are arranged to receive a cap member spanning the outer ends of the channels for selectively retaining the panel member within the channels.

The panel member may comprise a flat member which is slidable relative to the mounting frame along a plane of the panel member.

Preferably the sleeve member is supported on a pair of bearings spaced apart along the longitudinal axis and arranged to rotatably support the sleeve member on the post.

A leading member may be supported on the sleeve member diametrically opposite from the mounting frame and which has a mass which is arranged to counterbalance the mounting frame about the longitudinal axis. The leading member may taper aerodynamically in a radial direction so as to be narrower in cross section with increasing distance from the longitudinal axis.

The sleeve member may comprise two portions which are substantially symmetrical about a plane containing the longitudinal axis and about a plane of the panel member.

When the two portions of the sleeve member are arranged to surround the post when mated with one another, the mounting frame is preferably formed integrally with one of the portions of the sleeve member.

The sleeve member may be integrally enclosed at a top end thereof so as to be arranged to span overtop of the post.

There may be provided a light source supported on the sleeve member and oriented to project light radially outward in a direction of the mounting frame so as to be arranged to illuminate the panel member.

The light source may comprise a plurality of individual lights supported spaced apart in a row extending parallel to the longitudinal axis.

The panel member may comprise a body of clear material having a slot formed therein which receives an insert displaying the sign thereon such that the sign is visible through the clear material of the panel member when the insert is received in the slot of the panel member.

The light source may be arranged in communication with the panel member so as to transmit light through the material of the panel member onto the insert displaying the sign thereon.

The lights in this instance may be supported on the sleeve member and are arranged to be received within respective sockets formed in the panel member along an inner edge thereof.

There may be provided a wing member supported on the mounting frame spaced radially outward from the sleeve member in which the wing member being arranged to produce lift responsive to a horizontal wind thereacross.

In an alternative embodiment of the present invention, the mounting frame may comprise a channel extending substantially parallel to the longitudinal axis and having a generally U-shaped cross section with an open side of the channel facing radially outwardly for receiving an inner edge of the panel member therein.

Some embodiments of the invention will now be described in conjunction with the accompanying drawings in which:

### BRIEF DESCRIPTION OF THE DRAWINGS

FIG. 1 is a partially exploded perspective view of the device according to the present invention.

FIG. 2 is a top plan view of the device according to FIG. 1.

FIG. 3 is an exploded bottom view of the device according to FIG. 1.

FIG. 4 is a cross sectional view of the sleeve member along a plane of the sign panel.

FIG. 5 is a cross sectional view of the sleeve member at the axis of rotation along a vertical plane oriented perpendicularly to the sign.

FIG. 6 is a perspective view of a further embodiment of the sign supporting device.

In the drawings like characters of reference indicate corresponding parts in the different figures.

### DETAILED DESCRIPTION

Referring to the accompanying figures there is illustrated a sign supporting device generally indicated by reference numeral 10. The device 10 is particularly suited for supporting a sign, for example a flat panel 12 which permits advertising or other forms of signs to be displayed. The device 10 supports the panel 12 on a vertical post 14 supported in the ground such that the panel is rotatable about a vertical axis of the sleeve relative to the post.

Although various embodiments of the device 10 are described and illustrated herein, the common features of the various embodiments will first be described in the following description.

The device 10 comprises a sleeve member 16 which is rotatably supported about the post 14 by a pair of bearings 18 which are spaced apart in an axial direction of the sleeve member 16. The sleeve member 16 is rotatable relative to the post by the bearings about a longitudinal axis of the sleeve member which is aligned in the direction of the vertical axis of the post.

A mounting frame 20 extends radially outward from the sleeve member 16 in a first radial direction to support the panel 12 thereon. The panel 12 includes a sign displayed on both opposing flat surfaces of the panel. The mounting frame 20 supports the panel to be oriented vertically in a plane containing a longitudinal axis of rotation of the sleeve member 16 while projecting radially outward in one direction from the longitudinal axis. The mounting frame 20 supports the panel to be slidably removable from the mounting frame and sleeve member 16 in a radial direction within the vertical plane of the panel outwardly in the first direction relative to the longitudinal axis.

A releasable fastening mechanism 22 serves to selectively retain the insert panel 12 supported on the mounting frame 20. A leading member 24 is supporting on the sleeve member 16 to extending axially the length of the sleeve and to project radially outward from the sleeve diametrically opposite the mounting frame 20. The leading member 24 thus projects in a second direction opposite the first direction the mounting frame projects. The leading member is shorter in the radial direction relative to the longitudinal axis of the sleeve member than the mounting frame 20 and has a suitable mass to counterbalance a mass of the mounting frame about the longitudinal axis. The leading member 24 tapers aerodynamically to be reduced in cross section as it extends radially outward from the longitudinal axis so that the outer free leading edge of the leading member 24 is narrowest.

A wing member 26 is supported spaced radially outward from the sleeve member along the insert panel 12 adjacent a top edge thereof. The wing member comprises two wings 28 which extend laterally outward from opposing sides of the panel 12, tangentially to the longitudinal axis. The leading member 24, and the greater length of the mounting frame 20 in the radial direction as compared to the leading member, permit the panel to be oriented in the direction of the wind with the leading member facing into the wind and the panel trailing from the post relative to the wind.

The wing member 26 serves to produce lift when the wind blows thereacross to accommodate for the greater mass of the mounting frame and panel 12 combined relative to the counterbalance weight of the leading member 24. Balancing out the forces of gravity of the leading member 24 and the mounting frame can be accomplished by adjusting the weight thereof and the lift force produced by the wing member 26 relative to the longitudinal axis to promote easier rotation of the panel member about the post according to varying wind directions.

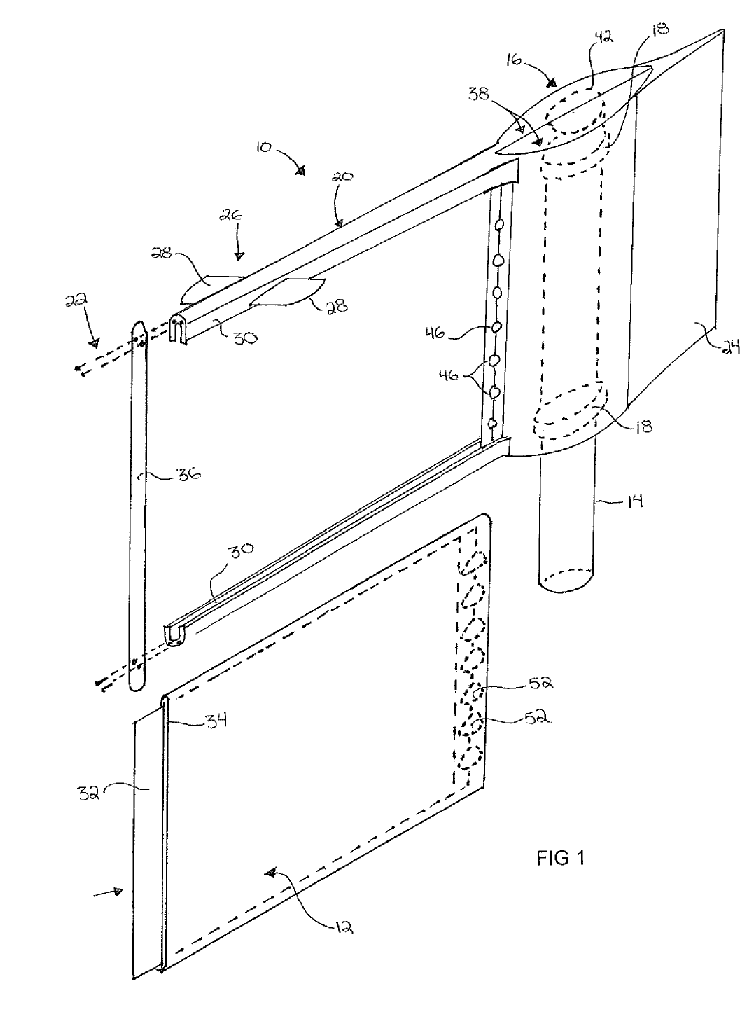

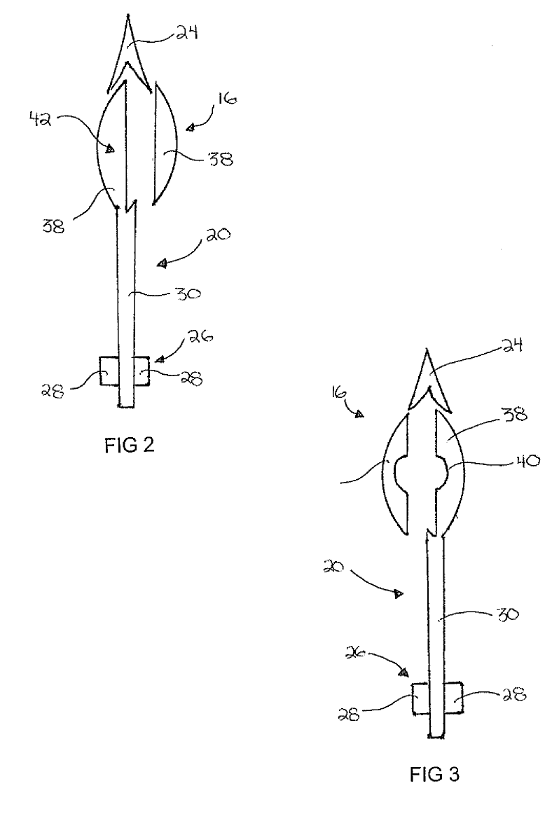

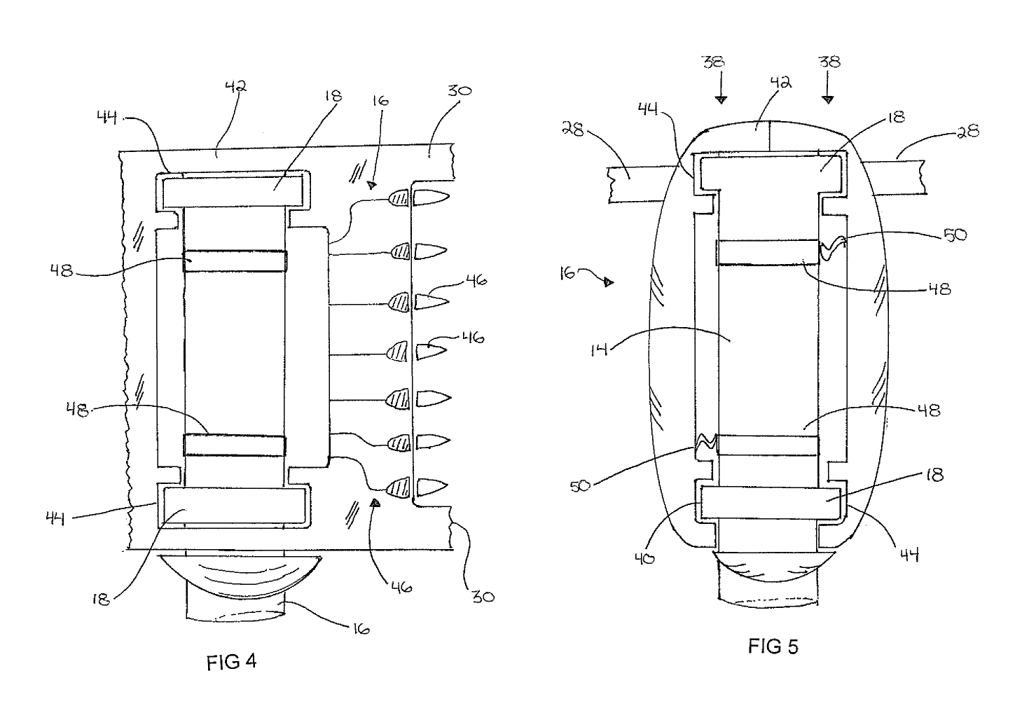

Turning now more particularly to the first embodiment shown in FIGS. 1 through 5, the mounting frame 20 is shown to comprise top and bottom channels 30 for receiving respective top and bottom edges of the panel 12 therein. The channels 30 are each generally U-shaped in cross section and extend radially outward from respective top and bottom ends of the sleeve member 16. The channels are oriented with respective open sides facing one another so that the panel 12 can be slidably received therein through open free ends of the channels opposite the sleeve member 16.

The panel 12 according to the first embodiment comprises a clear body for example formed of clear fibreglass or other suitable material which is substantially transparent, so that the sign can be printed on a flat insert 32 which is received within a mating slot 34 formed in the panel. The slot 34 is open along one end of the panel and extends substantially the height and length of the panel so that the insert 32 received therein is parallel to the two opposing flat sides of the panel which define the outer surfaces thereof where the sign is displayed. The insert 32 is readily slidably removed and inserted into the slot in the clear panel for replacement as desired.

An end cap 36 is arranged for spanning between the outer ends of the channels 30 opposite the sleeve member 16 to enclose the outer ends of the U-shaped channels and thereby retain the panel slidably received between the channels 30 when the end cap is mounted on the ends of the channels. The end cap 36 remains readily separable from the channels using threaded fasteners and the like to fasten the cap to the channels so that the full panel 12 can be removed from the mounting frame as desired. Removal of either the insert 32 from the panel or the panel from the mounting frame involves slidably removing the panel in a radial direction outward from the sleeve member 16 within a plane locating the longitudinal axis of the sleeve therein.

In the first embodiment the wing member 26 is mounted on the upper one of the channels 30 of the mounting frame so that the two wings 28 project laterally outward from opposing sides of the channel.

The sleeve member 16 of the first embodiment is formed in two portions 38 which are substantially identical to one another with the exception of the mounting frame 20 being integrally mounted onto one of the two portions 38. The two portions of the sleeve member are generally symmetrical with one another about the vertical plane of the panel 12 containing the longitudinal axis of the sleeve member so that the two portions 38 of the sleeve member divide the sleeve diametrically along a vertical dividing plane locating the longitudinal axis of the sleeve therein.

The inner ends of the channels 30 of the mounting frame, which are joined integrally with one of the two portions 38 of the sleeve, include a radially inward facing groove extending in the longitudinal direction of the sleeve member axis for receiving a longitudinally extending edge of the other one of the two portions 38 of the sleeve member therein when the two portions are mounted together in the assembled position. When the two portions 38 are assembled together a hollow tubular interior of the sleeve member 16 is defined which is connected with a through aperture 40 at the bottom end of the sleeve member while being enclosed at a top end by a suitable cap 42 formed by the two portions 38 of the sleeve member mated together at the top end of the device to extend over the post when assembled.

In the first embodiment the leading member 24 includes a longitudinally extending groove along the length thereof which is arranged to mate with the abutted edges of the two portions 38 of the sleeve member opposite the mounting frame so that when the edges of the two portions 38 of the sleeve member are received in the recess of the leading member 24 the leading member serves to retain the two portions of the sleeve member mated together in the assembled position of the sleeve member shown in FIG. 1.

The hollow tubular interior of the sleeve member 16 according to the first embodiment includes a pair of annular recess 44 extending circumferentially about the inner surface thereof at axially spaced positions along the long axis of the sleeve member 16. Each recess 44 receives a respective one of the bearings 18 which rotatably support the sleeve member 16 onto the post. The bearings are accordingly supported at axially spaced positions along the post.

A plurality of lights 46 are supported on the sleeve member in a vertical row at spaced positions in the direction of the longitudinal axis of the sleeve member.

The lights 46 are all supported on the portion of the sleeve member supporting the channels 30 integrally thereon and are arranged such that the light projected from the lights 46 projects radially outward from the sleeve structure in the first direction of the mounting frame to project light onto the panel 12 supported on the mounting frame. The lights 46 are thus all aligned with one another within a vertical plane of the panel 12 and of the longitudinal axis of the sleeve member. The lights 46 are supported on the inner end of the mounting frame 20 at the sleeve member 16 so as to be located along the inner edge of the panel 12 supported on the mounting frame.

Electrical power for illuminating the lights 46 is provided through electrical wiring which communicates with a pair of annular electrical contacts 48 mounted at spaced positions on the post between the bearings which support the sleeve on the post. A pair of sliding contacts 50 are supported on the inner surface of the sleeve member 16 for sliding engagement with the annular contacts 48 on the post so that as the sliding contacts 50 are rotated with the mounting frame and sleeve member relative to the post, they remain in electrical contact with the annular contacts 48 on the post. The sliding contacts 50 are in turn connected with the lights 46 to provide electrical power thereto.

An inner end of the panel 12 of the first embodiment includes a plurality of sockets 52 formed therein at spaced positions to form a vertical row along the inner edge of the panel. Each socket 52 is arranged for alignment with a respective one of the lights 46 to receive the bulb of the light therein. When assembled the lights 48 illuminate the clear material of the panel 12 and serve to transmit light through the clear material of the panel to illuminate both sides of the insert 32 so that the sign is illuminated.

In alternative embodiments the body of the panel may remain clear or translucent for transmitting light therethrough while the image is instead provided in the form of translucent coloured material on the outer surfaces of the panel rather than receiving an insert with the sign therein within the slot in the panel. The coloured material forming the sign on the outer surfaces of the panel in this instance would be backlit as opposed to the first embodiment in which the light shines through the clear plastic or fibreglass material forming the panel to illuminate opposing sides of a solid insert 32 received within the slot 34.

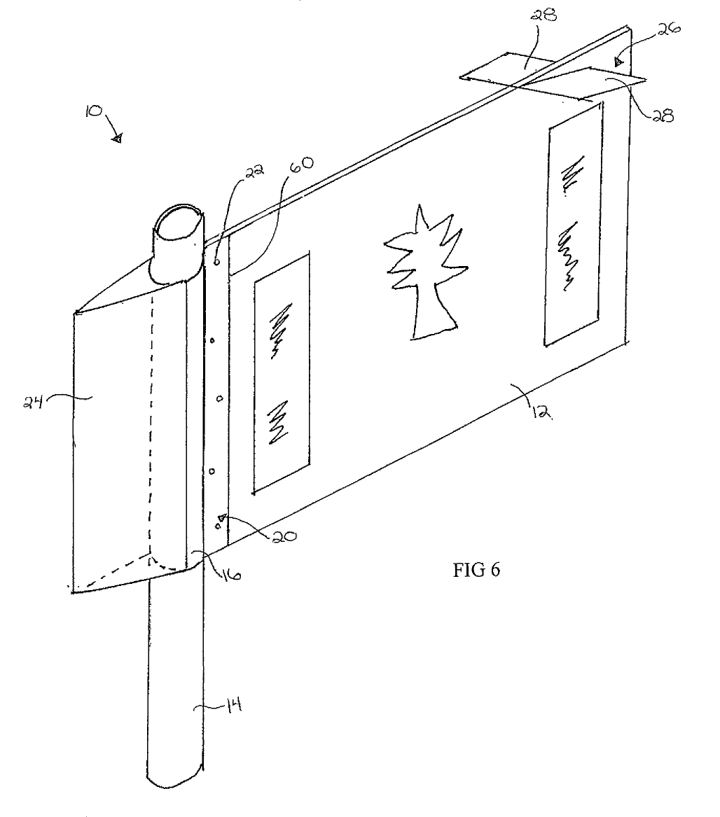

Turning now to a further embodiment of the device as shown in FIG. 6, in this instance the sleeve member 16 comprises a tube which is again supported on the post 14 by a pair of bearings. The leading member 24 in this instance is fastened directly into one side of the integral tube forming the sleeve member while the mounting frame 20 comprises a single channel diametrically opposite the leading member. The channel 60 according to the embodiment of FIG. 6 is generally U-shaped in cross section having an open side which faces radially outward away from the sleeve member 16 for slidably receiving the inner edge of the panel 12 therein. The fastening mechanism 22 in this instance comprises fasteners received through cooperating apertures in the opposed flanges of the channel 60 and the inner edge of the panel 12 so that the panel can be readily removed and replaced from the mounting frame by simply by removing the fasteners as desired.

The wing member 26 in the embodiment of FIG. 6 is arranged to be supported directly on the panel 12 spaced radially outward from the sleeve member 16 adjacent the top edge of the panel 12 so as to be located in a similar location as the first embodiment.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An aerodynamic sign displaying device for supporting a sign on a post, the device comprising:
a sleeve member arranged to be supported about the post for rotation relative to the post about a longitudinal axis of the sleeve member;
a mounting frame supported on the sleeve member to extend radially outward from the sleeve member in relation to the longitudinal axis; and
a panel member arranged to display the sign;
the panel member being slidably received in the mounting frame such that the panel member is readily separable from mounting frame.

2. The device according to claim 1 wherein the panel member is slidable relative to the mounting frame along a plane containing the longitudinal axis of the sleeve member.

3. The device according to claim 1 wherein the panel member is slidable relative to the mounting frame in a radial direction extending outwardly from the longitudinal axis of the sleeve member.

4. The device according to claim 1 wherein the mounting frame comprises a pair of channels having a generally U-shaped cross section oriented with respective open sides facing one another so as to be arranged for receiving respective top and bottom edges of the panel member slidably therein.

5. The device according to claim 4 wherein the channels extend radially outward from the longitudinal axis of the sleeve member and wherein there is provided a cap member spanning the outer ends of the channels for selectively retaining the panel member within the channels.

6. The device according to claim 1 wherein the panel member comprises a flat member which is slidable relative to the mounting frame along a plane of the panel member.

7. The device according to claim 1 wherein the sleeve member is supported on a pair of bearings spaced apart along the longitudinal axis and arranged to rotatably support the sleeve member on the post.

8. The device according to claim 1 wherein a leading member is supported on the sleeve member diametrically opposite from the mounting frame, the leading member having a mass which is arranged to counterbalance the mounting frame about the longitudinal axis.

9. The device according to claim 8 wherein the leading member tapers aerodynamically in a radial direction so as to be narrower in cross section with increasing distance from the longitudinal axis.

10. The device according to claim 1 wherein the sleeve member comprises two portions which are substantially symmetrical about a plane containing the longitudinal axis.

11. The device according to claim 1 wherein the sleeve member comprises two portions which are arranged to surround the post when mated with one another, the mounting frame being formed integrally with one of the portions of the sleeve member.

12. The device according to claim 1 wherein the sleeve member comprises two portions which are separated from one another about a plane of the panel member.

13. The device according to claim 1 wherein the sleeve member is integrally enclosed at a top end thereof so as to be arranged to span overtop of the post.

14. The device according to claim 1 wherein there is provided a light source supported on the sleeve member and oriented to project light radially outward in a direction of the mounting frame so as to be arranged to illuminate the panel member.

15. The device according to claim 14 wherein the light source comprises a plurality of individual lights supported spaced apart in a row extending parallel to the longitudinal axis.

16. The device according to claim 1 wherein the panel member comprises a body of clear material having a slot formed therein which receives an insert displaying the sign thereon such that the sign is visible through the clear material of the panel member when the insert is received in the slot of the panel member.

17. The device according to claim 16 wherein there is provided a light source in communication with the panel member which is arranged to transmit light through the material of the panel member onto the insert displaying the sign thereon.

18. The device according to claim 17 wherein the lights are supported on the sleeve member and are arranged to be received within respective sockets formed in the panel member along an inner edge thereof.

19. The device according to claim 1 wherein there is provided a wing member supported on the mounting frame spaced radially outward from the sleeve member, the wing member being arranged to produce lift responsive to a horizontal wind thereacross.

20. The device according to claim 1 wherein the mounting frame comprises a channel extending substantially parallel to the longitudinal axis and having a generally U-shaped cross section with an open side of the channel facing radially outwardly for receiving an inner edge of the panel member therein.
